(19) United States
(12) Patent Application Publication
(10) Pub. No.: US 2011/0205301 A1
(43) Pub. Date: Aug. 25, 2011

(54) Inkjet head

(75) Inventors: Jae Hun Kim, Seoul (KR); Jae-Sang Lee, Seoul (KR); Jae Woo Joung, Suwon (KR)

(73) Assignee: SAMSUNG ELECTRO-MECHANICS CO., LTD., Suwon (KR)

(21) Appl. No.: 12/926,186

(22) Filed: Oct. 29, 2010

(30) Foreign Application Priority Data
Feb. 23, 2010 (KR) 10-2010-0016254

(51) Int. Cl. B41J 2/135

(52) U.S. Cl. 347/44

(57) ABSTRACT

There is provided an inkjet head including: a body portion ejecting ink therein by a driving of an actuator; and a rigidity reinforcing portion coupled to an outer surface of the body portion and reducing deformation of the body portion during the ejecting of the ink.

### CROSS-REFERENCE TO RELATED APPLICATIONS

This application claims the priority of Korean Patent Application No. 10-2010-0016254 filed on Feb. 23, 2010, in the Korean Intellectual Property Office, the disclosure of which is incorporated herein by reference.

### BACKGROUND OF THE INVENTION

1. Field of the Invention

The present invention relates to an inkjet head, and more particularly, to an inkjet head allowing for a reduction in the deformation thereof when an actuator is driven.

2. Description of the Related Art

An inkjet head creates an image by ejecting ink droplets in a desired position. In recent years, an inkjet head has widely been used in industrial fields. For example, it is used to directly form a circuit pattern on a printed circuit board (PCB), create industrial graphics, or manufacture a liquid crystal display (LCD).

An inkjet head is divided into a thermal transfer inkjet head ejecting ink using the generation of bubbles caused by temperature variations and a piezoelectric inkjet head ejecting ink using variations in the volume of an ink chamber by applying a driving signal to a piezoelectric element.

In the case of a piezoelectric inkjet head, the size of droplets being ejected is very small, so printing quality may be influenced even by minute vibrations. When a piezoelectric element is driven, an inkjet head is instantly deformed, whereby a problem of printing quality may be caused.

Accordingly, there is a need for the development of technology achieving constant printing quality by reducing the deformation of an inkjet head when a piezoelectric element is driven.

### SUMMARY OF THE INVENTION

An aspect of the present invention provides an inkjet head achieving improved printing quality by reducing the deformation of the inkjet head when a piezoelectric element is driven.

According to an aspect of the present invention, there is provided an inkjet head including: a body portion ejecting ink therein by a driving of an actuator; and a rigidity reinforcing portion coupled to an outer surface of the body portion and reducing deformation of the body portion during the ejecting of the ink.

The rigidity reinforcing portion may include any one of a wire, a plate, or a lattice.

The rigidity reinforcing portion may be tightly coupled to side surfaces, a bottom surface, or both the side surfaces and the bottom surface of the body portion.

According to another aspect of the present invention, there is provided an inkjet head including: a body portion ejecting ink therein by a driving of an actuator; a rigidity reinforcing portion coupled to an outer surface of the body portion and reducing deformation of the body portion during the ejecting of the ink; and a coupling portion to be recessed into the outer surface of the body portion such that the rigidity reinforcing portion is coupled thereto.

The body portion may include an upper plate and a lower plate coupled to each other and have an ink chamber and a reservoir provided therein. An ink inlet, through which to draw ink into the reservoir, may be provided in an upper surface of the upper plate. A nozzle, through which to eject the ink, may be provided in a lower surface of the lower plate.

The coupling portion may be provided to be adjacent to the nozzle in order that the rigidity reinforcing portion may do not cover the nozzle.

The rigidity reinforcing portion may include any one of a wire, a plate, or a lattice to be inserted into the coupling portion.

The rigidity reinforcing portion may be tightly coupled to side surfaces, a bottom surface, or both the side surfaces and the bottom surface of the body portion.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an inkjet head according to an exemplary embodiment of the present invention;

FIG. 2 is a cross-sectional view taken along line A-A′ of FIG. 1;

FIG. 3 is a perspective view illustrating an inkjet head according to another exemplary embodiment of the present invention;

FIG. 4 is a cross-sectional view taken along line A-A′ of FIG. 3;

FIG. 5 is a perspective view illustrating an inkjet head according to another exemplary embodiment of the present invention; and

FIG. 6 is a cross-sectional view taken along line A-A′ of FIG. 5.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like elements.

In addition, when one element is referred to as being “connected” to another element, it should be understood that the former can be “directly connected” to the latter, or “indirectly connected” to the latter via an intervening element. Furthermore, unless explicitly described to the contrary, the word “include” and variations such as “includes” or “including,” will be understood to imply the inclusion of stated elements but not the exclusion of any other elements.

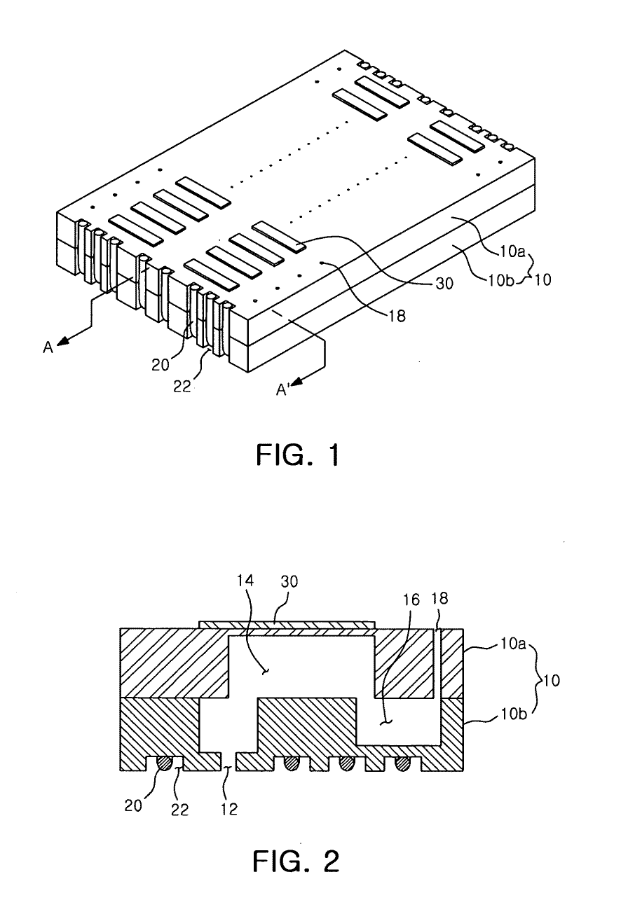

FIG. 1 is a perspective view illustrating an inkjet head according to an exemplary embodiment of the present invention.

With reference to FIG. 1, an inkjet head may include a body portion 10, a rigidity reinforcing portion 20 and an actuator 30.

The body portion 10 includes an upper plate 10a and a lower plate 10b. Inside the body portion 10, an ink chamber, a reservoir, and the like may be formed.

Also, an ink inlet 18 is formed in the body portion 10 in order that ink may be drawn into the body portion 10.

The actuator 30 is mounted on the upper surface of the body portion 10 and supplies pressure to the ink chamber formed inside the body portion 10 so that the ink may be ejected through a nozzle formed in a bottom surface of the body portion 10.

Here, the actuator 30 may be formed as a piezoelectric element that converts an electrical signal generated by a driving circuit (not shown) into mechanical pressure.

The rigidity reinforcing portion 20 may be coupled to the surface of the body portion 10.

Here, the rigidity reinforcing portion 20 may have the form of a wire as shown in FIG. 1, but is not limited thereto. Since the rigidity reinforcing portion 20 should reduce the deformation of the body portion 10, a material thereof may be selected so as to have appropriate rigidity and elasticity.

The rigidity reinforcing portion 20 having constant rigidity and elasticity is coupled to the bottom surface, the side surfaces or both the bottom surface and the side surfaces of the body portion 10 so that the deformation of the body portion 10 may be prevented. Particularly, in the case of a piezoelectric inkjet head, the body portion 10 may be deformed due to pressure produced during the driving of the actuator 30; however, the coupling of the rigidity reinforcing portion 20 with the body portion 10 may effectively reduce the deformation thereof.

Also, the body portion 10 may include a coupling portion 22 having a recess shape such that the rigidity reinforcing portion 20 may be easily coupled to the surface of the body portion 10.

FIG. 2 is a cross-sectional view taken along line A-A′ of FIG. 1.

With reference to FIG. 2, the body portion 10, formed by coupling the upper plate 10a and the lower plate 10b, has an ink chamber 14 and a reservoir 16 formed therein. The ink inlet 18 is formed in the upper surface of the upper plate 10a and a nozzle 12 is formed in the lower surface of the lower plate 10b.

The reservoir 16 receives ink drawn in from the outside and stores the ink. The reservoir 16 may be prepared by forming a recess having an inner space in the lower plate 10b.

The ink may be drawn from the outside to the reservoir 16 through the ink inlet 18. The body portion 10 may include a single ink inlet, or a plurality of ink inlets in the case of the inclusion of a plurality of ink chambers respectively corresponding thereto.

The reservoir 16 may be connected to the ink chamber 14 through a restrictor such that the ink stored in the reservoir 16 may be transferred to the ink chamber 14 through the restrictor.

Here, since the reservoir 16 may be disposed under the ink chamber 14, the restrictor may be formed inside the body portion 10 in a vertical direction.

The ink chamber 14 may be provided under the actuator 30. Here, a portion of the upper plate 10a that forms the ceiling of the ink chamber 14 serves as a vibration plate.

Therefore, when a driving signal is applied to the actuator 30 in order to eject ink, the actuator 30 and the vibration plate thereunder are deformed to thereby reduce the volume of the ink chamber 14.

The reduction in the volume of the ink chamber 14 increases the pressure inside the ink chamber 14, so that the ink inside the ink chamber 14 may be ejected to the outside through the nozzle 12.

The actuator 30 may include electrodes electrically connected to the upper and lower surfaces thereof. The actuator 30 may be formed of Plumbum Zirconate Titanate (PZT) ceramic which is a piezoelectric material.

Also, the coupling portion 22 having a recess shape is formed in the lower surface of the lower plate 10b, and the rigidity reinforcing portion 20 in the form of a wire is coupled thereto.

In this embodiment as depicted in FIG. 2, the rigidity reinforcing portion 20 is configured to be in the form of four wires; however, the number thereof may be varied, if desired.

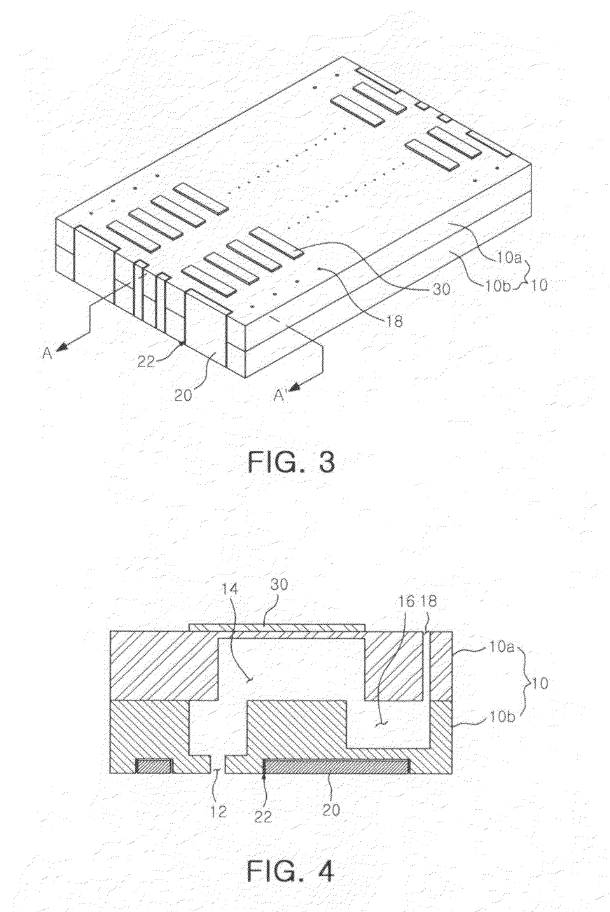

FIG. 3 is a perspective view illustrating an inkjet head according to another exemplary embodiment of the present invention.

With reference to FIG. 3, an inkjet head of this embodiment is the same as that of the aforementioned embodiment depicted in FIG. 1, except that the rigidity reinforcing portion 20 has the form of a plate.

In the case of the inkjet head according to the embodiment depicted in FIG. 3, the rigidity reinforcing portion 20 having the form of a plate almost encloses the side surfaces and bottom surface of the body portion 10, and thus the deformation of the body portion 10 may be effectively reduced.

FIG. 4 is a cross-sectional view taken along line A-A′ of FIG. 3.

With reference to FIG. 4, the rigidity reinforcing portion 20 in the form of a plate is coupled to the body portion 10 without covering the nozzle 12 formed in the bottom surface of the body portion 10. To enable this, the coupling portion 22 is formed to be adjacent to the nozzle 12.

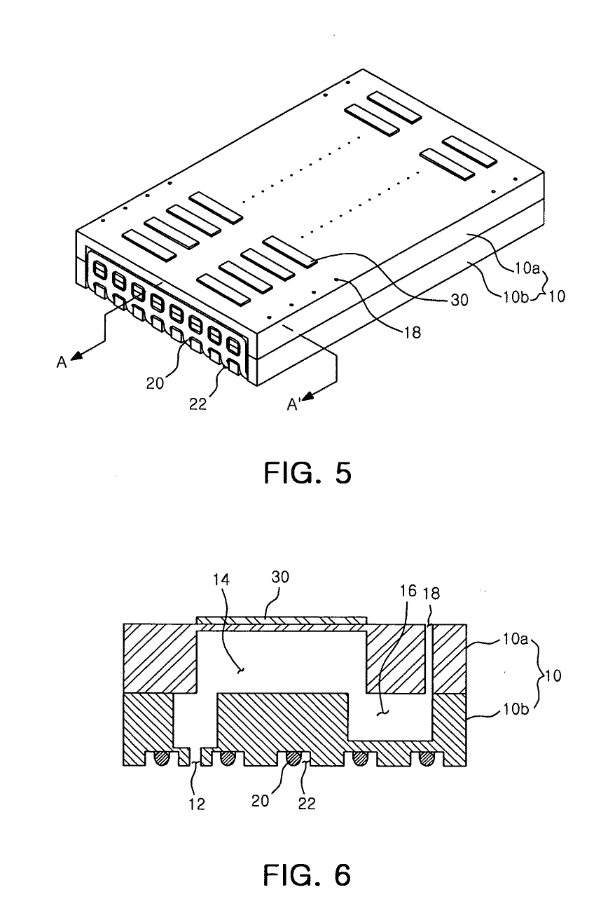

FIG. 5 is a perspective view illustrating an inkjet head according to another exemplary embodiment of the present invention.

With reference to FIG. 5, an inkjet head of this embodiment is the same as that of the aforementioned embodiment depicted in FIG. 1, except that the rigidity reinforcing portion 20 has the form of a lattice.

In the case of the inkjet head according to the embodiment depicted in FIG. 5, the rigidity reinforcing portion 20 having the form of a lattice encloses the side surfaces and bottom surface of the body portion 10, and thus the deformation of the body portion 10 may be effectively reduced.

FIG. 6 is a cross-sectional view taken along line A-A′ of FIG. 5.

With reference to FIG. 6, the rigidity reinforcing portion 20 in the form of a lattice is coupled to the body portion 10 without covering the nozzle 12 formed in the bottom surface of the body portion 10.

Although not shown herein, the rigidity reinforcing portion 20, may be freely selected to have a variety of forms in addition to a wire, plate, or lattice form in order that it may effectively reduce the deformation of the body portion 10.

As set forth above, according to exemplary embodiments of the invention, an inkjet head having a rigidity reinforcing portion allows for a reduction in the deformation thereof caused by the driving of a piezoelectric element, whereby printing quality is improved.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
a body portion ejecting ink therein by a driving of an actuator; and
a rigidity reinforcing portion coupled to an outer surface of the body portion and reducing deformation of the body portion during the ejecting of the ink.

2. The inkjet head of claim 1, wherein the rigidity reinforcing portion comprises any one of a wire, a plate, or a lattice.

3. The inkjet head of claim 1, wherein the rigidity reinforcing portion is tightly coupled to side surfaces, a bottom surface, or both the side surfaces and the bottom surface of the body portion.

4. An inkjet head comprising:
a body portion ejecting ink therein by a driving of an actuator;
a rigidity reinforcing portion coupled to an outer surface of the body portion and reducing deformation of the body portion during the ejecting of the ink; and
a coupling portion to be recessed into the outer surface of the body portion such that the rigidity reinforcing portion is coupled thereto.

5. The inkjet head of claim 4, wherein the body portion includes an upper plate and a lower plate coupled to each other and has an ink chamber and a reservoir provided therein,
an ink inlet, through which to draw ink into the reservoir, is provided in an upper surface of the upper plate, and
a nozzle, through which to eject the ink, is provided in a lower surface of the lower plate.

6. The inkjet head of claim 5, wherein the coupling portion is provided to be adjacent to the nozzle in order that the rigidity reinforcing portion does not cover the nozzle.

7. The inkjet head of claim 4, wherein the rigidity reinforcing portion comprises any one of a wire, a plate, or a lattice.

8. The inkjet head of claim 4, the rigidity reinforcing portion is tightly coupled to side surfaces, a bottom surface, or both the side surfaces and the bottom surface of the body portion.
